(19) United States
(12) Patent Application Publication
(10) Pub. No.: US 2025/0044478 A1
(43) Pub. Date: Feb. 6, 2025

(54) SYSTEM AND METHOD OF MULTI-MODAL MULTI-TASK ENVIRONMENTAL QUALITY FORECASTING

(71) Applicant: Ambient Ridge, Inc., Mt. Kisco, NY (US)

(72) Inventor: Dylan LEWIS, Union City, NJ (US)

(73) Assignee: Ambient Ridge, Inc., Mt. Kisco, NY (US)

(21) Appl. No.: 18/792,269

(22) Filed: Aug. 1, 2024

Related U.S. Application Data
(60) Provisional application No. 63/530,669, filed on Aug. 3, 2023.

(51) Int. Cl. G01W 1/10

(52) U.S. Cl. CPC G01W 1/10

(57) ABSTRACT

In a method of multi-modal multi-task environmental quality forecasting, multi-modal data associated with a plurality of environmental input features is received. A neural sub-network of a plurality of neural sub-networks is applied to each modality of the multi-mode data associated with each environmental input feature of the plurality of environmental input features. A neural network is applied to outputs of each of the plurality of neural sub-networks, wherein the neural network includes a trained model for forecasting the plurality of environmental qualities. An environmental quality forecast is output for the plurality of environmental qualities.

### RELATED APPLICATION

This application claims priority to and the benefit of co-pending U.S. Provisional Patent Application 63/530,669, filed on Aug. 3, 2023, entitled “SYSTEM FOR FORECASTING OF ENVIRONMENTAL HEALTH INFORMATION,” by Dylan Lewis, having Attorney Docket No. AR-003.PRO, and assigned to the assignee of the present application, which is incorporated herein by reference in its entirety.

### BACKGROUND

Concerns about environmental hazards, such as air quality as well as soil and water contamination, are increasing in volume and frequency. Environmental and natural hazard information is important for allowing individuals, property developers and owners, as well as renters, to know and understand the climate and environmental hazard and risk information associated with the locations. There are a myriad of sources for obtaining certain types of environmental and natural hazard information, such as government institutions at the national, regional, and local level, as well as private organizations. This information may not be in a consumer digestible format that is decipherable to users in a way that provides useful information to users for evaluating climate and environmental hazards and risks for a location. In particular, conventional solutions for providing such information typically provide only historic or real-time information related to environmental hazards.

### BRIEF DESCRIPTION OF DRAWINGS

The accompanying drawings, which are incorporated in and form a part of the Description of Embodiments, illustrate various embodiments of the subject matter and, together with the Description of Embodiments, serve to explain principles of the subject matter discussed below. Unless specifically noted, the drawings referred to in this Brief Description of Drawings should be understood as not being drawn to scale. Herein, like items are labeled with like item numbers.

FIG. 1 is a block diagram illustrating an embodiment of an example system for transforming and searching environmental hazard and risk information, according to embodiments.

FIG. 2 is a block diagram illustrating an example environmental hazard and risk data transformation module, according to an embodiment.

FIG. 3A is a block diagram illustrating an example multi-modal multi-task environmental quality forecasting model, according to an embodiment.

FIG. 3B is a block diagram illustrating an example multi-modal multi-task environmental quality forecasting model for forecasting soil, water, and air quality, according to an embodiment.

FIG. 4 illustrates an example multi-modal multi-task environmental quality forecasting model for forecasting soil, water, and air quality, according to other embodiments.

FIG. 5 illustrates a block diagram of an example computer system upon which embodiments of the present invention can be implemented.

FIG. 6 illustrates a flow diagram illustrating an example method for multi-modal multi-task environmental quality forecasting, in accordance with embodiments.

### DESCRIPTION OF EMBODIMENTS

Reference will now be made in detail to various embodiments of the subject matter, examples of which are illustrated in the accompanying drawings. While various embodiments are discussed herein, it will be understood that they are not intended to be limited to these embodiments. On the contrary, the presented embodiments are intended to cover alternatives, modifications and equivalents, which may be included within the spirit and scope of the various embodiments as defined by the appended claims. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail as not to unnecessarily obscure aspects of the described embodiments.

Some portions of the detailed descriptions which follow are presented in terms of procedures, logic blocks, processing and other symbolic representations of operations on data bits within a computer memory. These descriptions and representations are the means used by those skilled in the data processing arts to most effectively convey the substance of their work to others skilled in the art. In the present application, a procedure, logic block, process, or the like, is conceived to be one or more self-consistent procedures or instructions leading to a desired result. The procedures are those requiring physical manipulations of physical quantities. Usually, although not necessarily, these quantities take the form of electrical or magnetic signals capable of being stored, transferred, combined, compared, and otherwise manipulated in an electronic device.

It should be borne in mind, however, that all of these and similar terms are to be associated with the appropriate physical quantities and are merely convenient labels applied to these quantities. Unless specifically stated otherwise as apparent from the following discussions, it is appreciated that throughout the description of embodiments, discussions utilizing terms such as “receiving,” “receiving,” “applying,” “outputting,” “determining,” “identifying,” “comparing,” “generating,” “executing,” “configuring,” “storing,” “directing,” “accessing,” “updating,” “collecting,” or the like, refer to the actions and processes of an electronic computing device or system such as: a host processor, a processor, a memory, a cloud-computing environment, a hyper-converged appliance, a software defined network (SDN) manager, a system manager, a virtualization management server or a virtual machine (VM), among others, of a virtualization infrastructure or a computer system of a distributed computing system, or the like, or a combination thereof. The electronic device manipulates and transforms data represented as physical (electronic and/or magnetic) quantities within the electronic device's registers and memories into other data similarly represented as physical quantities within the electronic device's memories or registers or other such information storage, transmission, processing, or display components.

Embodiments described herein may be discussed in the general context of processor-executable instructions or code residing on some form of non-transitory processor-readable medium, such as program modules, executed by one or more computers or other devices. Generally, program modules include routines, programs, objects, components, data structures, etc., that perform particular tasks or implement particular abstract data types. The functionality of the program modules may be combined or distributed as desired in various embodiments.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example mobile electronic device described herein may include components other than those shown, including well-known components.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium comprising instructions that, when executed, perform one or more of the methods described herein. The non-transitory processor-readable data storage medium may form part of a computer program product, which may include packaging materials.

The non-transitory processor-readable storage medium may include random access memory (RAM) such as synchronous dynamic random access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, code and instructions described in connection with the embodiments disclosed herein may be executed by one or more processors, such as one or more motion processing units (MPUs), sensor processing units (SPUs), host processor(s) or core(s) thereof, digital signal processors (DSPs), general purpose microprocessors, application specific integrated circuits (ASICs), application specific instruction set processors (ASIPs), field programmable gate arrays (FPGAs), or other equivalent integrated or discrete logic circuitry. The term “processor,” as used herein may refer to any of the foregoing structures or any other structure suitable for implementation of the techniques described herein. In addition, in some aspects, the functionality described herein may be provided within dedicated software modules or hardware modules configured as described herein. Also, the techniques could be fully implemented in one or more circuits or logic elements. A general purpose processor may be a microprocessor, but in the alternative, the processor may be any conventional processor, controller, microcontroller, or state machine. A processor may also be implemented as a combination of computing devices, e.g., a combination of an SPU/MPU and a microprocessor, a plurality of microprocessors, one or more microprocessors in conjunction with an SPU core, MPU core, or any other such configuration.

### Overview of Discussion

There is an increasing demand across individuals and various types of organizations (including, for example, insurers and real estate businesses) for reliable and accessible information about relevant environmental hazards and how they may change in the future to inform business investment decisions, risk management, and mitigation and resiliency plans. Many businesses are simultaneously facing new or increasing challenges regarding environment-related risk management. Many companies face mounting pressure from stakeholders to alter their behaviors, such as by reducing their environmental impacts or by preparing for potential environmental impacts. Also, various regulatory or corporate requirements impose environmental risk monitoring, compliance or reporting obligations on businesses.

To begin addressing such needs, a climate and environmental intelligence geospatial system that delivers location-based reports with an integrated hazard data repository has been developed. The system, which includes an objective algorithmic scoring engine, geomaps, and other features, also offers enterprise solutions with an extensive set of 30+ natural, industrial, pollution, and infrastructure topics. This system is helpful to inform decision makers given its localized information, which is largely current and historical information. Embodiments described herein complement this system by providing future forecasting of climate and environmental information for use in long-term planning or decisions.

Businesses, communities and governments are increasingly demanding extensive and forecasted local environmental information and, in some cases, across potentially interconnecting topics to learn about and prepare for a changing climate and environmental landscape. Embodiments described herein provide data-driven predictive simulations that predict and combine multiple climate and environmental issues for forecasting future climate and environmental predictive results. In some embodiments, in order to scale to areas which experience data scarcity, the described system uses satellite images to operate in these areas.

Embodiments described herein provide a geo-spatial forecasting model using big data techniques to make forecasts of climate, health and/or safety qualities of areas across the world. This model leverages an extensive database of environmental hazard and risk data, utilizing multiple environmental hazards (e.g., climate, industrial, pollution, infrastructure) as well as satellite imagery to learn from multi-modal inputs simultaneously, and predict how they may affect climate, health and/or safety qualities of the environment. The model of the described embodiments is applicable for use in areas for which there are variable amounts of data to inform the model's forecasting. In accordance with some embodiments, the model is supplemented by using satellite images which addresses issues of data scarcity in affected regions.

The environment is changing rapidly and with enormous economic consequences, including for real estate and insurance. Therefore, businesses and others need an understanding of how environmental qualities will change in their locations to position themselves for the future. However, there are, for example, currently no conventional models using satellite data that provide long term forecasts of air, soil, and water quality, likely due to their significant predicting challenges. Air, soil, and water quality depend on the complex interaction of many environmental variables. Additionally, data that would serve as input to these models can be scarce and/or noisy. The described embodiments overcome these challenges to address the growing demand among businesses, communities, and governments for localized forecasted climate or environmental health in the context of climate change by providing data-driven predictive models using satellite data to enrich the data for improved forecasting of climate predictions and, in certain cases such as for air, soil, and water predictions for example, integrating potentially interconnected climate and environmental factors to make more precise predictions and anticipate shifts in a region's health and safety conditions.

In accordance with various embodiments, the system described herein is configured to employ a large dataset of environmental variables, covering climate and industrial risks, historical data, pollution, and satellite data. This array of multi-modal inputs enables the model to understand, when applicable, intricate interactions among these numerous input variables. The described system is capable of forecasting future air, water, and soil qualities in a given area.

Embodiments described herein provide a method of multi-modal multi-task environmental quality forecasting. Multi-modal data associated with a plurality of environmental input features is received. In some embodiments, the multi-modal data includes tabular data, time-series data, and satellite image data. In some embodiments, the plurality of environmental qualities includes air quality, soil quality, and water quality. In some embodiments, it is determined whether local data of the multi-modal data is unavailable for at least one environmental input feature of the plurality of environmental input features. Masking features are applied to the portion of the multi-modal data that is unavailable if deemed appropriate; these masking features indicate the absence of some of the multi-modal data.

A neural sub-network of a plurality of neural sub-networks is applied to each modality of the multi-modal input data if deemed warranted. In some embodiments, the plurality of neural sub-networks includes a recurrent neural sub-network, a fully-connected neural sub-network, and a convolutional neural sub-network. In some embodiments, applying the neural sub-network of the plurality of neural sub-networks to each modality of the multi-modal data includes applying a fully-connected neural sub-network to the tabular data, applying a recurrent neural sub-network to the time-series data, and applying a convolutional neural sub-network to the satellite image data. In some embodiments, the plurality of neural sub-networks are applied to their respective modality of the multi-modal data simultaneously.

A neural network is applied to outputs of each of the plurality of neural sub-networks, the neural network including a trained model for forecasting the plurality of environmental qualities. In some embodiments, the neural network is a fully-connected neural network. A forecast for air, soil, and water qualities is the output.

### Example System for Transformation of Inconsistent Environmental and Natural Hazard Data

Example embodiments described herein provide systems and methods for generating accessible and easy to understand information from data sources that are often inconsistent and disparate. The data, coming from disparate sources and in different types, is transformed into consistent data that can be compared and analyzed appropriately in a normalized fashion. This search data can be customized according to search preferences, to provide an improved and enhanced user experience.

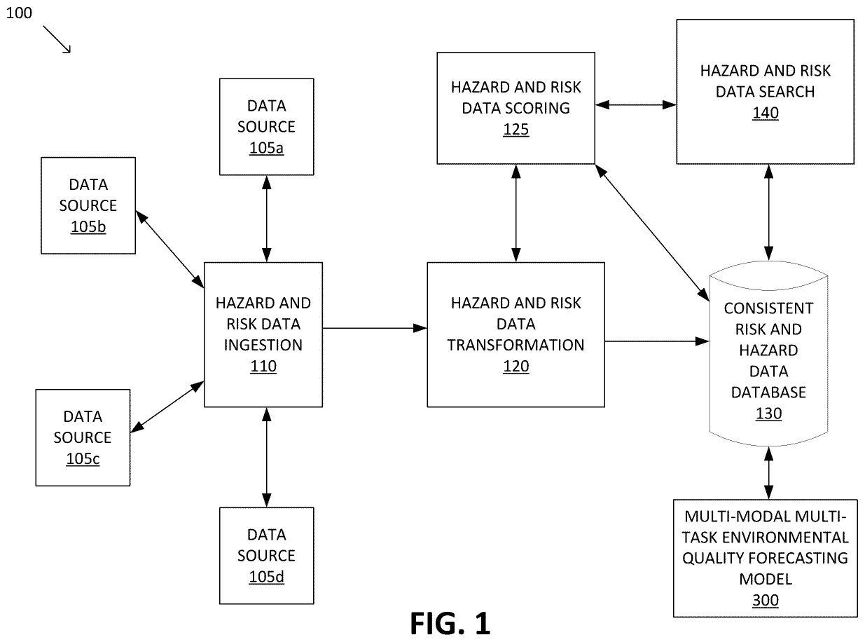

FIG. 1 is a block diagram illustrating an embodiment of an example system 100 for transforming and searching environmental hazard and risk information, according to embodiments. System 100 includes hazard and risk data ingestion module 110 for ingesting data from disparate data source 105a thorough 105d, hazard and risk data transformation module 120, hazard and risk data scoring 125, consistent hazard and risk data database 130, and hazard and risk data search module 140. It should be appreciated that hazard and risk data ingestion module 110, hazard and risk data transformation module 120, hazard and risk data scoring 125, consistent hazard and risk data database 130, and hazard and risk data search module 140 can be under the control of a single component of an enterprise computing environment (e.g., a computer system 500) or can be distributed over multiple components. In some embodiments, system 100 includes multi-modal multi-task environmental quality forecasting model 300 for use in forecasting future environmental quality for a number of features, such as soil quality, water quality, and air quality.

It should be appreciated that system 100 may ingest data at hazard and risk data ingestion module 110 from a variety of sources, including open data sources such as federal government databases, e.g., the Environmental Protection Agency (EPA) or the National Oceanic and Atmospheric Administration (NOAA), as well as state, local city, county and other databases. A repository of satellite images, such as Sentinel-Hub which is a repository of satellite images spanning across the US over time, can be used to retrieve satellite images.

In accordance with some embodiments, hazard data is requested from data sources 105a-d. For example, a CRON Based Lambda Function that runs periodically (e.g., daily) makes an HTTP POST Request to a data source 105a. For example, an HTTP Post Request can be made to an EPA Facility Registry Service (FRS) MapServer to request particular information. In a specific example, the request can be for information marked “ACRES” to identify brownfield locations. In some embodiments, the data received is reconciled against stored data to determine whether new data is received. If there is no new data received after comparison to the stored data, the process completes. If new data is identified, the data is forwarded to hazard and risk data transformation module 120.

It should be appreciated that data can be received from data sources 105a-d in a variety of modalities, such as tabular data, time-series data, satellite imagery, etc. Each data source may provide the data in one or more modalities. In some embodiments, data received can be processed at ingestion node 110. For example, data received in one modality may be transformed into another modality, such as converting tabular data to time-series data, or satellite imagery can be denoised to improve image quality.

The data is received at hazard and risk data transformation module 120 and, coming from disparate sources and in different types, is transformed into consistent data that can be compared and analyzed appropriately in a normalized fashion. The consistent data is stored at consistent hazard and risk data database 130. Hazard and risk data search module 140 is configured to receive and perform searches on the data of consistent hazard and risk data database 130.

Conventional environmental and natural hazard information is typically varied and complex in terms of data source, data type, and data formats, such that the data is inconsistent across different sources, making comparison generally unachievable across different sources. The underlying data for these types of data can be particularly challenging. These challenges include:
the difficulty in locating or accessing certain data;
the fragmentation of the data (in some cases with respect to the same hazard and in other cases across hazards);
the inconsistency with which that data is presented (in some cases with respect to the same hazard and in other cases across hazards);
how technical or scientific the information is where available, making it hard to understand or interpret for the average consumer; and
the different frequencies with which the datasets update (giving rise to different “pull” frequencies).

The described embodiments address these challenges, enabling the ingestion of relevant environmental health and natural hazards' or potential risks' information and produce meaningful reports. In order to allow comparisons and analyses of such data, embodiments described herein transform the data to provide standardized data that is capable of being compared.

After the data has been accessed and ingested, the system is configured to transform the data by standardizing or normalizing the data, and aggregating the data to prepare the data for the geospatial, scoring, weighting and selection innovations designed to enable the platform's features.

The system ingests and then transforms a range of types of data, much of which is environmental health and natural hazard data with inconsistency challenges as described above, pertaining to various areas across a region (e.g., the United States) to provide consistency or compatibility to that data:
1. presented on geomaps for the entire geographic space for which the data is received;
2. with usable interfaces created or designed to provide the information in ways to make it more understandable and accessible; and
3. then processes to standardize and/or normalize the data across the region such that area risk data is able to be transposed onto geomaps and to be subject to processing search, scoring, comparing and/or weighing the data.

Because this integrated data is often not “clean” data, significant standardization and/or normalization work is often necessary in addition to reconciliation work to prepare the data and to verify its integrity as it is ingested and then integrated onto the environmental and natural hazards intelligence platform and database.

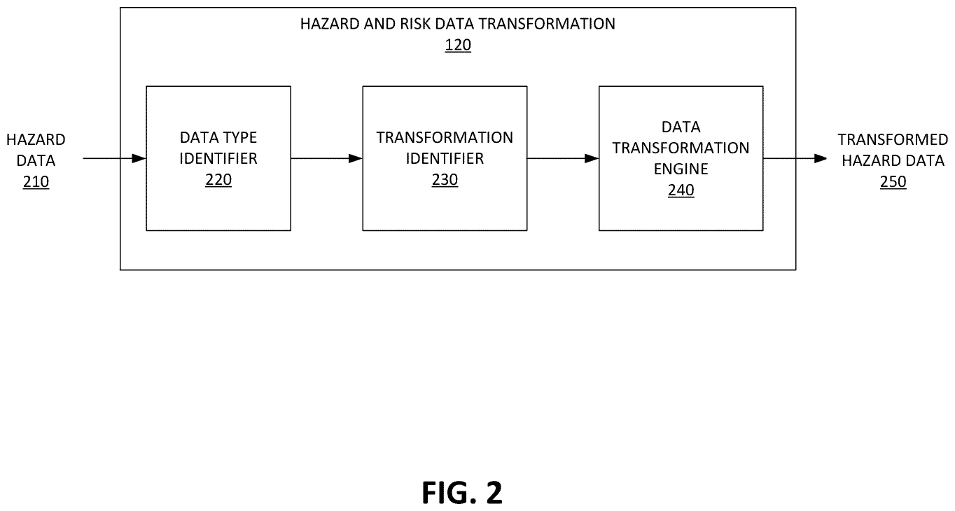

FIG. 2 is a block diagram illustrating an example environmental hazard and risk data transformation module 120, according to an embodiment. Environmental hazard and risk data transformation module 120 includes data type identifier 220, transformation identifier 230, and data transformation engine 240. It should be appreciated that data type identifier 220, transformation identifier 230, and data transformation engine 240 can be under the control of a single component of an enterprise computing environment (e.g., a computer system 500) or can be distributed over multiple components.

Hazard data 210 is received (e.g., from hazard and risk data ingestion module 110) at data type identifier 220 of environmental hazard and risk data transformation module 120. Data type identifier 220 is configured to inspect hazard data 210 and to determine a data type of hazard data 210. For example, data received from an EPA Facility Registry Service (FRS) MapServer may be received in a GeoJSON format (e.g., to describe brownfield locations). The data is further inspected at transformation identifier 230 to determine what type of transformation or transformations to apply to hazard data 210 upon identification of the data type.

At data transformation engine 240, hazard data 210 is transformed according to the transformation or transformations identified at transformation identifier 230. For example, transformations to hazard data 210 can include: renaming object keys (e.g., changing facility_name to name), changing geospatial projections (e.g., transforming EPSG: 4269 data format to EPSG: 4326 data format), transforming GeoJSON results into a standardized JSON format, etc. Data transformation engine 240 generates transformed hazard data 250, and forwards transformed hazard data 250 to consistent hazard and risk data database 130 for storage. For example, transformed hazard data 250 is forwarded as a GraphQL Mutation to the consistent hazard and risk data database 130. In some embodiments, consistent hazard and risk data database 130 is a geographic information system (GIS) database.

In some embodiments, concurrent or subsequent the generation of transformed hazard data 250, hazard and risk data scoring 125 performs an area-based scoring operation on the transformed hazard data 250. Performing the area-based scoring operation at this point allows for the precomputation and storage of the precomputed scores, that can ultimately be returned responsive to search request. This is of particular advantage for large and dynamic datasets, such as those pertaining to air quality index (AQI), so as to provide a fast response time. In some embodiments, data sets having less data (e.g., brownfields or nuclear plants) can be computed at request time. It should be appreciated that the scoring operation can be performed at search time or at ingestion, and that the precomputation allows for the reduction of computational resources used at the time of the search.

Scoring operations are applied to the hazard data (e.g., transformed hazard data) to provide information of the relative risk associated with particular hazards. The scoring operations are applied to an area, also referred to herein as a geozone. In accordance with some embodiments, the geozone based scoring operation appends locations with geozone based datasets (e.g., counties, zip codes, census tracts, or any other polygon based feature).

Locations are appended with geozone based datasets (e.g., counties, zip codes, census tracts, or any other polygon based feature). Various operations can be used to append the locations using different operations, such as and without limitation: Overlapping Hierarchical Clustering (OHC), DBScan, and K-means analysis. New densities (e.g., of brownfields) are applied within the geozones as parameters to the scoring algorithm which precomputes a score. It should be appreciated that these operations generally associate risks and hazards, and the scores thereof, to geographic regions (e.g., geozones).

Hazard and risk data scoring 125 forwards the scoring information to consistent hazard and risk data database 130 for storage along with the associated hazard data. For example, the scoring information is forwarded as a GraphQL Mutation to the consistent hazard and risk data database 130.

### Example System of Multi-Modal Multi-Task Environmental Quality Forecasting

Example embodiments described herein provide systems and methods of multi-modal multi-task environmental quality forecasting. The described system is multi-modal in that it receives data of multiple modalities (e.g., tabular data, time-series data, and satellite image data) and is multi-task in that it is capable of performing forecasting on multiple environmental qualities simultaneously using multiple neural sub-networks. The modality specific neural sub-networks are combined at a final neural network with outputs representing future forecasts of environmental qualities. Since the forecasting of the plurality of environmental qualities is performed simultaneously, hence multi-task, the composite model (all sub-networks combined) is able to capture shared learnings between tasks, e.g., learning to perform water quality forecasting can help to inform better forecasting of soil quality and vice-versa.

The climate and environment of an area is sometimes dependent on the complex relationship between its climate risk, industry, pollution, and infrastructure features. The extensive multi-modal input data, including satellite imagery, used in the model described herein provides a forecasting solution that can be used even in instances of data scarcity. By leveraging widespread satellite images as inputs and providing a model that can handle various data availability scenarios, the described forecasting model becomes applicable in any region. Deep learning techniques are leveraged in multiple ways to facilitate accurate geospatial forecasting of climate-related factors or future air, soil, and water qualities in the face of multiple potentially interconnected hazards.

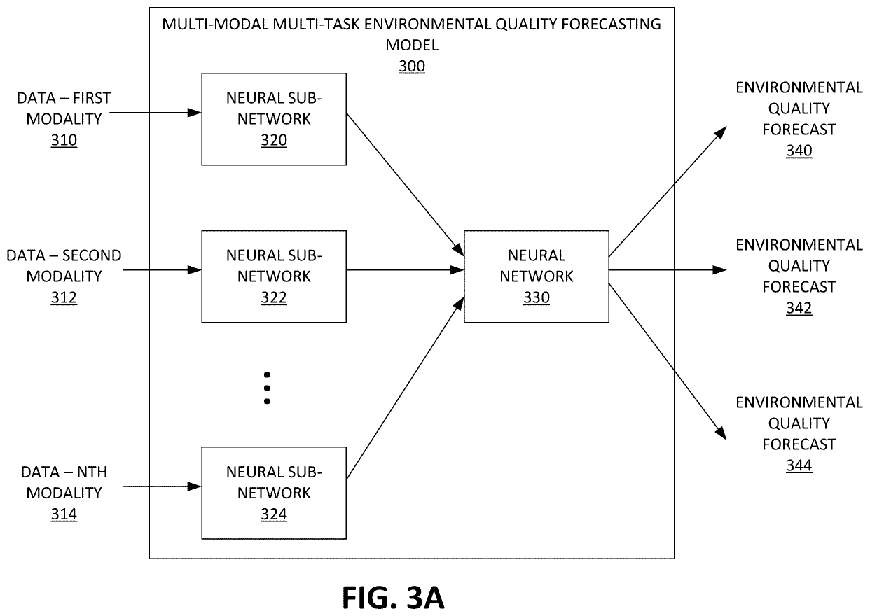

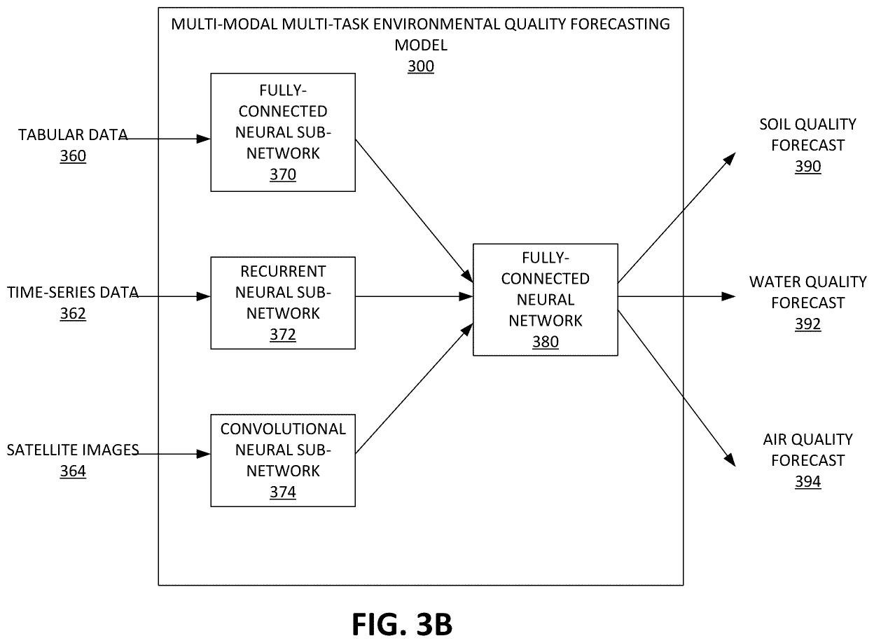

FIG. 3A is a block diagram illustrating an example multi-modal multi-task environmental quality forecasting model 300, according to an embodiment. Forecasting model 300 includes neural sub-networks 320, 322, and 324, each of which is communicatively coupled to neural network 330. Neural sub-networks 320, 322, and 324 are configured to receive and process data of different modalities (e.g., tabular data, time-series data, image data, etc.) Neural sub-network 320 is configured to receive and process first modality data 310, neural sub-network 322 is configured to receive and process second modality data 312, and neural sub-network 324 is configured to receive and process third modality data 314. In some embodiments, neural sub-networks 320, 322, and 324 include a recurrent neural sub-network, a fully-connected neural sub-network, and a convolutional neural sub-network. The output of modality-specific neural sub-networks 320, 322, and 324, are combined using a final neural network 330 with outputs representing future environmental quality forecasts 340, 342, and 344 for an area. Neural network 330 of the environmental qualities forecasting model 300 ultimately learns the data representation shared between the tasks.

The described forecasting model 300 forecasts future environmental qualities for an area using the multi-modal input data 310, 312, and 314 representing the environmental features of the area (e.g., number of toxic release facilities, tornadoes, prior air quality measurements, etc.). Since the multiple environmental quality forecast outputs 340, 342, and 344 of forecasting model 300 leverage the same multi-modal input data 310, 312, and 314, forecasting model 300 is a multi-task model, performing the tasks of environmental quality forecasting of different environmental qualities simultaneously. Forecasting model 300 is trained on the complex interactions between the multi-modal input features for an area as it relates to the output variables (e.g., future air, soil, and water qualities), learning a representation of the data that is shared between the tasks. Internally, forecasting model 300 is trained to transform the raw input modalities into a format useful for forecasting tasks. Since this learned representation, or transformation, is shared between the forecasting tasks of different environmental features, forecasting model 300 learns a representation of the data which is generally useful across tasks. For instance, features learned as part of this transformation for one task can be useful for another task, and vice-versa.

It should be appreciated that forecasting model 300 can process any number of data modalities, and comprise the corresponding number of modality-specific neural sub-networks, and that the described embodiments are not limited to the illustrated embodiment of FIG. 3A. Furthermore, neural network 330 can be used to forecast environmental quality for any number of output variables, and is not limited to the illustrated embodiment.

FIG. 3B is a block diagram illustrating another example multi-modal multi-task environmental quality forecasting model 300 for forecasting soil, water, and air quality, according to an embodiment. Forecasting model 300 includes fully-connected neural sub-network 370, recurrent neural sub-network 372, and convolutional neural sub-network 374, each of which is communicatively coupled to fully-connected neural network 380. Fully-connected neural sub-network 370, recurrent neural sub-network 372, and convolutional neural sub-network 374 are configured to receive and process data of different modalities. Fully-connected neural sub-network 370 is configured to receive and process tabular data 360, recurrent neural sub-network 372 is configured to receive and process time-series data 362, and convolutional neural sub-network 374 is configured to receive and process satellite image data 364. The outputs of modality-specific fully-connected neural sub-network 370, recurrent neural sub-network 372, and convolutional neural sub-network 374, are combined using fully-connected neural network 380 with outputs representing soil quality forecast 390, water quality forecast 392, and air quality forecast 394 for an area. Fully-connected neural network 380 of the environmental qualities forecasting model 300 ultimately learns the data representation shared between the tasks.

The described forecasting model 300 forecasts future environmental qualities for an area using the multi-modal tabular data 360, time-series data 362, and satellite image data 364 representing the environmental features of the area (e.g., number of toxic release facilities, tornadoes, prior air quality measurements, etc.). Since the multiple environmental quality forecast outputs soil quality forecast 390, water quality forecast 392, and air quality forecast 394 of forecasting model 300 leverage the same multi-modal tabular data 360, time-series data 362, and satellite image data 364, forecasting model 300 is a multi-task model, performing the forecasting of different environmental qualities simultaneously. Forecasting model 300 is trained on the complex interactions between the multi-modal input features for an area as it relates to the output variables (e.g., future air, soil, and water qualities), learning a representation of the data that is shared between the tasks. Internally, forecasting model 300 is trained to transform the raw input modalities into a format useful for forecasting tasks. Since this learned representation, or transformation, is shared between the forecasting tasks of different environmental qualities, forecasting model 300 learns a representation of the data which is generally useful across tasks. For instance, features learned as part of this transformation for one task can be useful for another task, and vice-versa.

Data aggregated for an area by the system described herein includes geospatial time-series data 362 (e.g., climate risk, pollution hazards) and tabular data 360 (e.g., number of toxic waste facilities, tornadoes, etc.). Neural networks (e.g., deep learning models) are capable of handling different data modalities quite effectively. The described system employs a neural network 380 that can specialize in learning a meaningful representation from each data modality and develop modality-specific sub-networks (e.g., fully-connected neural sub-network 370, recurrent neural sub-network 372, and convolutional neural sub-network 374). The modality-specific neural sub-networks 370, 372, and 374 are combined using fully-connected neural network 380 with outputs representing soil quality forecast 390, water quality forecast 392, and air quality forecast 394 for an area.

In some embodiments, for the inputs to fully-connected neural sub-network 370 used for processing tabular data 360 and recurrent neural sub-network 372 used for processing time-series data 362, an additional set of masking features can be added. These masking features indicate if the original tabular data 360 or time-series data 362 input features, or any portion thereof, are missing. This approach augments the inputs to fully-connected neural sub-network 370 and the recurrent neural sub-network 372, allowing forecasting model 300 to learn how to handle the case when a portion or subset of modality data is missing (e.g., only some of the tabular data features are missing) via masking features. Additionally, at the fusion step where the output of neural sub-networks 370, 372, and 374, are processed by fully-connected neural network 380, when all data for a specific modality is missing (e.g., all time-series data is missing), a vector of zeros is utilized for that particular missing modality.

Embodiments described herein, in conjunction with a climate and environmental database of environmental data (e.g., consistent hazard and risk data database 130 of FIG. 1), enhance forecasting model 300 by incorporating satellite data and/or images 364 as an additional input. Satellite imagery and associated information has proven to be a valuable resource in enriching the forecasting model's input and improving the accuracy of forecasting climate risks and air, water, and soil qualities.

Using satellite images 364, in addition to other local data modalities available for an area, can improve the accuracy of forecasting model 300 towards forecasting future climate risks and/or air, soil, and water qualities over the localized modalities alone. In instances where some local data is missing, or the extreme instance where there are only satellite images available in an area, forecasting model 300 is trained to improve its accuracy across these various data scarcity situations by exposing it to real-world instances of data scarcity and having the model make use of satellite images 364 as an additional input.

Local input features that the described system 100 aggregates and utilizes may not always be available in some areas of the United States or the world. For instance, some areas that face wildfire risk and contain toxic chemical industrial facilities have nearby sensors, while others do not. As such, in accordance with various embodiments, masking features and satellite images are used as additional inputs. Masking features identify data for which local data is unavailable. Satellite images 364 are used to supplement in situations where local data is available, partially available, or entirely unavailable, enhancing performance of forecasting model 300.

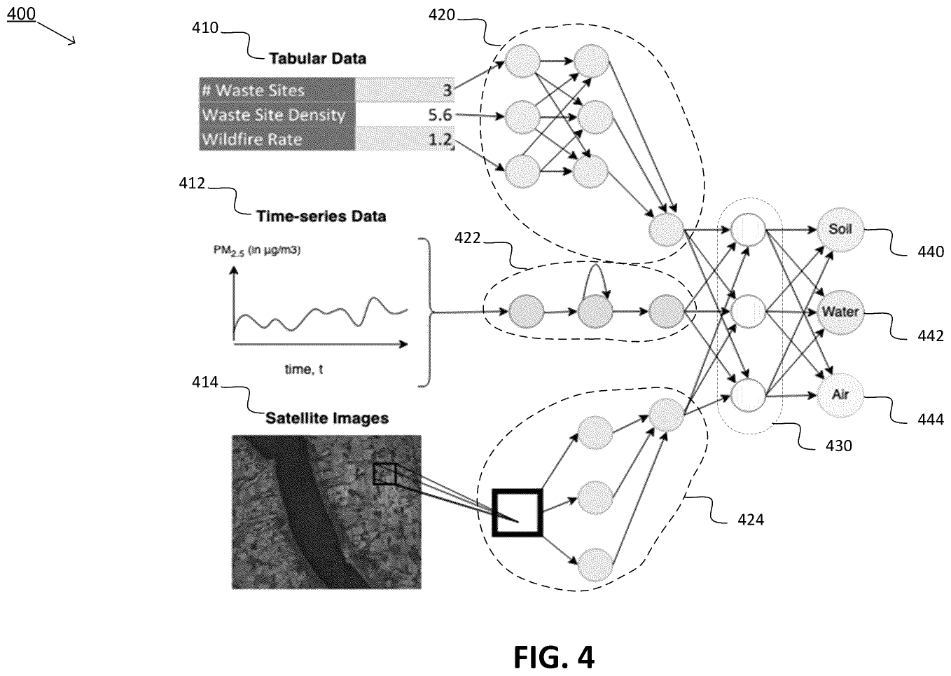

FIG. 4 illustrates an example multi-modal multi-task environmental quality forecasting model 400 for forecasting soil, water, and air quality, according to other embodiments. Forecasting model 400 includes neural sub-networks 420, 422, and 424, each of which is communicatively coupled to neural network 430. Neural sub-networks 420, 422, and 424 are configured to receive and process data of different modalities, tabular data 410, time-series data 412, and satellite image data 414. Neural sub-network 420 is configured to receive and process tabular data 410, neural sub-network 422 is configured to receive and process time-series data 412, and neural sub-network 424 is configured to receive and process satellite image data 414. In some embodiments, neural sub-network 420 is a fully-connected neural sub-network, neural sub-network 422 is a recurrent neural sub-network, and neural sub-network 424 is a convolutional neural sub-network. The output of modality-specific neural sub-networks 420, 422, and 424, are combined using fully-connected neural network 430 with outputs representing future soil quality forecast 440, water quality forecast 442, and air quality forecast 444 for an area. Fully-connected neural network 430 of the environmental qualities forecasting model 400 ultimately learns the data representation shared between the tasks.

The described forecasting model 400 forecasts future environmental qualities for an area using the multi-modal tabular data 410, time-series data 412, and satellite image data 414 representing the environmental features of the area (e.g., number of toxic release facilities, tornadoes, prior air quality measurements, etc. in this example). Since soil quality forecast 440, water quality forecast 442, and air quality forecast 444 of forecasting model 400 leverage the same multi-modal tabular data 410, time-series data 412, and satellite image data 414, forecasting model 400 is a multi-task model, performing the tasks of environmental quality forecasting of different environmental qualities simultaneously. Forecasting model 400 is trained on the complex interactions between the multi-modal input features for an area as it relates to the output variables (e.g., future climate, air, soil, or water qualities), learning a representation of the data that is shared between the tasks. Internally, forecasting model 400 is trained to transform the raw input modalities into a format useful for forecasting tasks. Since this learned representation, or transformation, is shared between the forecasting tasks of different environmental qualities, forecasting model 400 learns a representation of the data which is generally useful across tasks. For instance, features learned as part of this transformation for one task can be useful for another task, and vice-versa.

Disparities in data availability across the United States, and world, can impact the accuracy of forecasting model 400. Consequently, regions plagued by data scarcity are commonly left at a disadvantage, at risk of not being able to reap the benefits offered by our advanced forecasting system. Embodiments described herein provide a forecasting model 400 that might encounter the most extreme case of data scarcity: all data is missing for an area. This would mean that forecasting model 400 would have no input signal to inform its forecasting for areas that experience this extreme degree of data scarcity. Since data scarcity impacts the universality forecasting model 400, embodiments described herein use masking features to the model and satellite images as an additional widespread data source.

Satellite images have the potential to greatly assist in forecasting climate risks and environmental qualities, particularly in data-scarce areas. By using local environmental data, such as sensor data, when it is available in addition to satellite imagery, the described system enriches the forecasting model's understanding of climate risks or the complex interactions of climate risk and localized environmental features (e.g., wildfires, toxic waste facilities, etc.) and their effects on air, water, and soil quality. This will enable forecasting model 400 to be applied to similar scenarios using sensor data and other available environmental input features when they are available alongside satellite imagery or to draw solely upon satellite images as input when there are no other environmental input features. With satellite images, this extreme case of data scarcity is remedied by giving forecasting model 400 at the very least a satellite image to use as an input for its forecasting. As a reliable, widely available data source, satellite images can be used in any data availability scenario.

In some embodiments, for the inputs to fully-connected neural sub-network 420 used for processing tabular data 410 and recurrent neural sub-network 422 used for processing time-series data 412, an additional set of masking features can be added. These masking features indicate if the original tabular data 410 or time-series data input 412 features, or any portion thereof, are missing. This approach augments the inputs to fully-connected neural sub-network 420 and recurrent neural sub-network 422, allowing forecasting model 400 to learn how to handle the case when a portion or subset of modality data is missing (e.g., only some of the tabular data features are missing) via masking features. Additionally, at the fusion step where the output of neural sub-networks 420, 422, and 424 are processed by the neural network 430, when all data for a specific modality is missing (e.g., all time-series data is missing), a vector of zeros is utilized for the missing modality.

Embodiments described herein provide a solution that has the potential to impact the behavior of businesses, communities, governments, and individuals by assisting them in decision-making in regard to the forecasted climate risks and/or forecasted environmental health and safety qualities for their area. Relatedly, the forecasting technology can lead to better decision making that can increase economic opportunity by attracting consumers to areas that are forecasted to have reduced climate exposures and high health and safety qualities—or that can encourage efforts to mitigate the risk to areas with forecasted negative impacts. Communities and citizens will be able to understand how their climate risk picture is changing or how the environmental health and safety qualities of their environment will be impacted in the future. This will empower them to make better decisions, such as more health-conscious or better investment or planning decisions, which can lead to positive societal health and welfare or financial outcomes in the short and long-term. Businesses that incorporate this forecasted information into their decision making (such as when they are selecting clients in which to invest, lend or insure) could, over time, reduce certain liability risks or the likelihood of performance volatility arising from risks not previously considered or not considered to the same extent. Economic decisions and investments (e.g. buying property) made from consumers and businesses also have the potential to impact the economy.

### Example Computer System

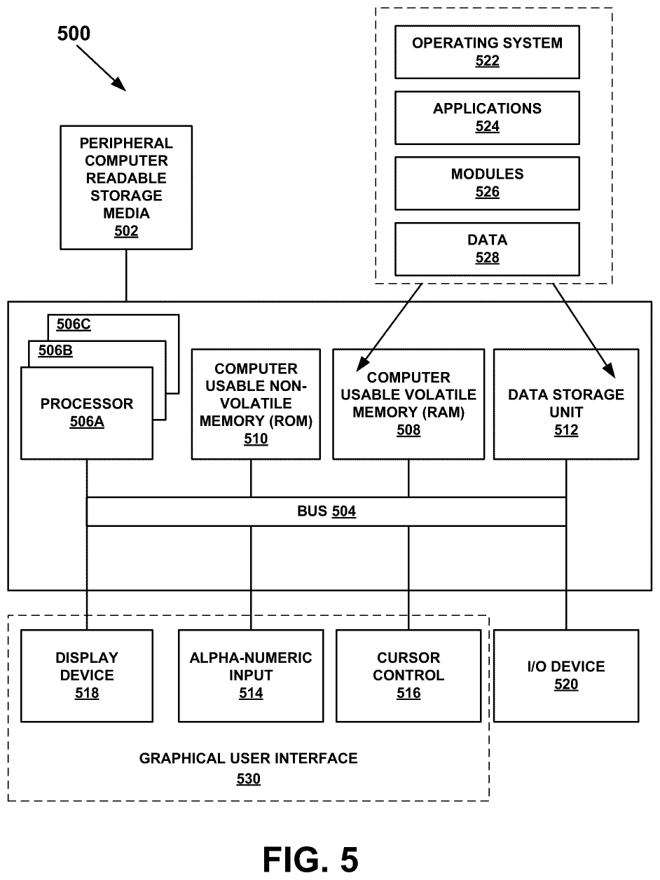

FIG. 5 is a block diagram of an example computer system 500 upon which embodiments of the present invention can be implemented. FIG. 5 illustrates one example of a type of computer system 500 (e.g., a computer system) that can be used in accordance with or to implement various embodiments which are discussed herein.

It is appreciated that computer system 500 of FIG. 5 is only an example and that embodiments as described herein can operate on or within a number of different computer systems including, but not limited to, general purpose networked computer systems, embedded computer systems, mobile electronic devices, smart phones, server devices, client devices, various intermediate devices/nodes, standalone computer systems, media centers, handheld computer systems, multi-media devices, and the like. In some embodiments, computer system 500 of FIG. 5 is well adapted to having peripheral tangible computer-readable storage media 502 such as, for example, an electronic flash memory data storage device, a floppy disc, a compact disc, digital versatile disc, other disc based storage, universal serial bus “thumb” drive, removable memory card, and the like coupled thereto. The tangible computer-readable storage media is non-transitory in nature.

Computer system 500 of FIG. 5 includes an address/data bus 504 for communicating information, and a processor 506A coupled with bus 504 for processing information and instructions. As depicted in FIG. 5, computer system 500 is also well suited to a multi-processor environment in which a plurality of processors 506A, 506B, and 506C are present. Conversely, computer system 500 is also well suited to having a single processor such as, for example, processor 506A. Processors 506A, 506B, and 506C may be any of various types of microprocessors. Computer system 500 also includes data storage features such as a computer usable volatile memory 508, e.g., random access memory (RAM), coupled with bus 504 for storing information and instructions for processors 506A, 506B, and 506C. Computer system 500 also includes computer usable non-volatile memory 510, e.g., read only memory (ROM), coupled with bus 504 for storing static information and instructions for processors 506A, 506B, and 506C. Also present in computer system 500 is a data storage unit 512 (e.g., a magnetic or optical disc and disc drive) coupled with bus 504 for storing information and instructions. Computer system 500 also includes an alphanumeric input device 514 including alphanumeric and function keys coupled with bus 504 for communicating information and command selections to processor 506A or processors 506A, 506B, and 506C. Computer system 500 also includes a cursor control device 516 coupled with bus 504 for communicating user input information and command selections to processor 506A or processors 506A, 506B, and 506C. In one embodiment, computer system 500 also includes a display device 518 coupled with bus 504 for displaying information.

Referring still to FIG. 5, display device 518 of FIG. 5 may be a liquid crystal device (LCD), light emitting diode display (LED) device, cathode ray tube (CRT), plasma display device, a touch screen device, or other display device suitable for creating graphic images and alphanumeric characters recognizable to a user. Cursor control device 516 allows the computer user to dynamically signal the movement of a visible symbol (cursor) on a display screen of display device 518 and indicate user selections of selectable items displayed on display device 518. Many implementations of cursor control device 516 are known in the art including a trackball, mouse, touch pad, touch screen, joystick or special keys on alphanumeric input device 514 capable of signaling movement of a given direction or manner of displacement. Alternatively, it will be appreciated that a cursor can be directed and/or activated via input from alphanumeric input device 514 using special keys and key sequence commands. Computer system 500 is also well suited to having a cursor directed by other means such as, for example, voice commands. In various embodiments, alphanumeric input device 514, cursor control device 516, and display device 518, or any combination thereof (e.g., user interface selection devices), may collectively operate to provide a graphical user interface (GUI) 530 under the direction of a processor (e.g., processor 506A or processors 506A, 506B, and 506C). GUI 530 allows user to interact with computer system 500 through graphical representations presented on display device 518 by interacting with alphanumeric input device 514 and/or cursor control device 516.

Computer system 500 also includes an I/O device 520 for coupling computer system 500 with external entities. For example, in one embodiment, I/O device 520 is a modem for enabling wired or wireless communications between computer system 500 and an external network such as, but not limited to, the Internet. In one embodiment, I/O device 520 includes a transmitter. Computer system 500 may communicate with a network by transmitting data via I/O device 520.

Referring still to FIG. 5, various other components are depicted for computer system 500. Specifically, when present, an operating system 522, applications 524, modules 526, and data 528 are shown as typically residing in one or some combination of computer usable volatile memory 508 (e.g., RAM), computer usable non-volatile memory 510 (e.g., ROM), and data storage unit 512. In some embodiments, all or portions of various embodiments described herein are stored, for example, as an application 524 and/or module 526 in memory locations within RAM 508, computer-readable storage media within data storage unit 512, peripheral computer-readable storage media 502, and/or other tangible computer-readable storage media.

### Example Methods of Operation

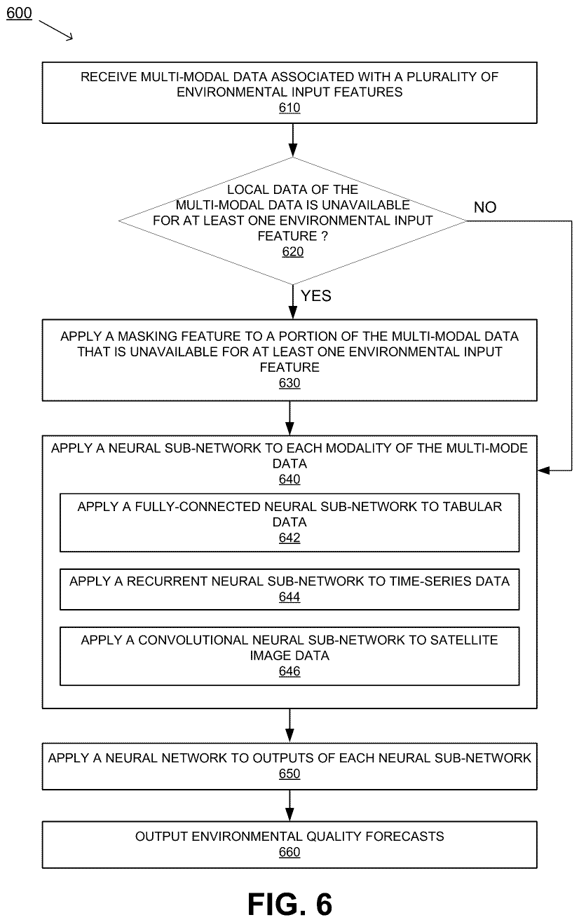

The following discussion sets forth in detail the operation of some example methods of operation of embodiments. With reference to FIG. 6, flow diagram 600 illustrates example procedures used by various embodiments. The flow diagram 600 includes some procedures that, in various embodiments, are carried out by a processor under the control of computer-readable and computer-executable instructions. In this fashion, procedures described herein and in conjunction with the flow diagrams are, or may be, implemented using a computer, in various embodiments. The computer-readable and computer-executable instructions can reside in any tangible computer readable storage media. Some non-limiting examples of tangible computer readable storage media include random access memory, read only memory, magnetic disks, solid state drives/“disks,” and optical disks, any or all of which may be employed with computer environments (e.g., computer system 500). The computer-readable and computer-executable instructions, which reside on tangible computer readable storage media, are used to control or operate in conjunction with, for example, one or some combination of processors of the computer environments and/or virtualized environment. It is appreciated that the processor(s) may be physical or virtual or some combination (it should also be appreciated that a virtual processor is implemented on physical hardware). Although specific procedures are disclosed in the flow diagram, such procedures are examples. That is, embodiments are well suited to performing various other procedures or variations of the procedures recited in the flow diagram. Likewise, in some embodiments, the procedures in flow diagram 600 may be performed in an order different than presented and/or not all of the procedures described in flow diagram 600 may be performed. It is further appreciated that procedures described in flow diagram 600 may be implemented in hardware, or a combination of hardware with firmware and/or software provided by computer system 500.

FIG. 6 illustrates a flow diagram 600 illustrating an example method for multi-modal multi-task environmental quality forecasting, in accordance with embodiments. At procedure 610 of flow diagram 600, multi-modal data associated with a plurality of environmental input features is received. In some embodiments, the multi-modal data includes tabular data, time-series data, and satellite image data. In some embodiments, the plurality of environmental input features is related to, for example, air quality, soil quality, or water quality. In some embodiments, as shown at procedure 620, it is determined whether local data of the multi-modal data is unavailable for at least one environmental input feature of the plurality of environmental input features. Provided local data of the multi-modal data is unavailable for at least one environmental input feature, as shown at procedure 630, a masking feature is applied to a portion of the multi-modal data that is unavailable for at least one environmental input feature of the plurality of environmental input features, the masking feature indicating an absence of the local data of the multi-modal data. Provided local data of the multi-modal data is not unavailable for at least one environmental input feature, flow diagram 600 proceeds to procedure 640.

At procedure 640, a neural sub-network of a plurality of neural sub-networks is applied to each modality of the multi-mode data. In some embodiments, the plurality of neural sub-networks includes a recurrent neural sub-network, a fully-connected neural sub-network, and a convolutional neural sub-network. In some embodiments, as shown at procedure 642, a fully-connected neural sub-network is applied to the tabular data, as shown at procedure 644, a recurrent neural sub-network is applied to the time-series data, and, as shown at procedure 646, a convolutional neural sub-network is applied to the satellite image data. In some embodiments, applying the neural sub-network of the plurality of neural sub-networks to each modality of the multi-mode data is performed simultaneously for the plurality of neural sub-networks.

At procedure 650, a neural network is applied to outputs of each of the plurality of neural sub-networks, the neural network including a trained model for forecasting the plurality of environmental qualities. In some embodiments, the neural network is a fully-connected neural network. At procedure 660, an environmental quality forecast is output for the plurality of environmental qualities.

It is noted that any of the procedures, stated above, regarding flow diagram 600 of FIG. 6 may be implemented in hardware, or a combination of hardware with firmware and/or software. For example, any of the procedures are implemented by a processor(s) of a cloud environment and/or a computing environment.

### CONCLUSION

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. The description as set forth is not intended to be exhaustive or to limit the embodiments to the precise form disclosed. Rather, the specific features and acts described above are disclosed as example forms of implementing the claims. In the claims, elements and/or steps do not imply any particular order of operation, unless explicitly stated in the claims.

Reference throughout this document to “one embodiment,” “certain embodiments,” “an embodiment,” “various embodiments,” “some embodiments,” or similar term means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

Many variations, modifications, additions, and improvements are possible, regardless of the degree of virtualization. Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claims(s).

What is claimed is:

1. A method of multi-modal multi-task environmental quality forecasting, the method comprising:
receiving multi-modal data associated with a plurality of environmental input features;
applying a neural sub-network of a plurality of neural sub-networks to each modality of the multi-mode data associated with each environmental input feature of the plurality of environmental input features;
applying a neural network to outputs of each of the plurality of neural sub-networks, the neural network comprising a trained model for forecasting a plurality of environmental qualities; and
outputting an environmental quality forecast for the plurality of environmental qualities.

2. The method of claim 1, wherein the multi-modal data comprises tabular data, time-series data, and satellite image data.

3. The method of claim 2, wherein the applying the neural sub-network of the plurality of neural sub-networks to each modality of the multi-mode data associated with each environmental input feature of the plurality of environmental input features comprises:
applying a fully-connected neural sub-network to the tabular data;
applying a recurrent neural sub-network to the time-series data; and
applying a convolutional neural sub-network to the satellite image data.

4. The method of claim 1, wherein the applying the neural sub-network of the plurality of neural sub-networks to each modality of the multi-mode data associated with each environmental input feature of the plurality of environmental input features is performed simultaneously for the plurality of neural sub-networks.

5. The method of claim 1, wherein the plurality of environmental qualities comprises air quality, soil quality, and water quality.

6. The method of claim 1, wherein the plurality of neural sub-networks comprises a recurrent neural sub-network, a fully-connected neural sub-network, and a convolutional neural sub-network.

7. The method of claim 1, wherein the plurality of neural sub-networks are combined using a fully-connected neural network.

8. The method of claim 1, further comprising:
determining whether local data of the multi-modal data is unavailable for at least one environmental input feature of the plurality of environmental input features; and
applying a masking feature to a portion of the multi-modal data that is unavailable for at least one environmental input feature of the plurality of environmental input features, the masking feature indicating an absence of the local data of the multi-modal data.

9. A non-transitory computer readable storage medium having computer readable program code stored thereon for causing a computer system to perform a method of multi-modal multi-task environmental quality forecasting, the method comprising:
receiving multi-modal data associated with a plurality of environmental input features, the multi-modal data comprising tabular data, time-series data, and satellite image data, wherein the plurality of environmental input features are related to air quality, soil quality, and water quality;
applying a neural sub-network of a plurality of neural sub-networks to each modality of the multi-mode data associated with each environmental input feature of the plurality of environmental input features, the plurality of neural sub-networks comprising a recurrent neural sub-network, a fully-connected neural sub-network, and a convolutional neural sub-network;
applying a neural network to outputs of each of the plurality of neural sub-networks, the neural network comprising a trained model for forecasting a plurality of environmental qualities; and
outputting an environmental quality forecast for the air quality, the soil quality, and the water quality.

10. The non-transitory computer readable storage medium of claim 9, wherein the applying the neural sub-network of the plurality of neural sub-networks to each modality of the multi-mode data associated with each environmental input feature of the plurality of environmental input features comprises:
applying the fully-connected neural sub-network to the tabular data;
applying the recurrent neural sub-network to the time-series data; and
applying the convolutional neural sub-network to the satellite image data.

11. The non-transitory computer readable storage medium of claim 9, wherein the applying the neural sub-network of the plurality of neural sub-networks to each modality of the multi-mode data associated with each environmental quality of the plurality of environmental qualities is performed simultaneously for the plurality of neural sub-networks.

12. The non-transitory computer readable storage medium of claim 9, wherein the plurality of neural sub-networks are combined using a fully-connected neural network.

13. The non-transitory computer readable storage medium of claim 9, the method further comprising:
determining whether local data of the multi-modal data is unavailable for at least one environmental input feature of the plurality of environmental input features; and
applying a masking feature to a portion of the multi-modal data that is unavailable for at least one environmental input feature of the plurality of environmental input features, the masking feature indicating an absence of the local data of the multi-modal data.

14. A method of multi-modal multi-task environmental quality forecasting, the method comprising:
receiving multi-modal data associated with a plurality of environmental input features the multi-modal data comprising tabular data, time-series data, and satellite image data;
determining whether local data of at least one of the tabular data and the time-series data is unavailable for at least one environmental input feature of the plurality of environmental input features;
applying a masking feature to a portion of the multi-modal data that is unavailable for at least one of the tabular data and the time-series data, the masking feature indicating an absence of the local data of the multi-modal data;
applying a neural sub-network of a plurality of neural sub-networks to each modality of the multi-mode data associated with each environmental input feature of the plurality of environmental input features;
applying a neural network to outputs of each of the plurality of neural sub-networks, the neural network comprising a trained model for forecasting a plurality of environmental qualities; and
outputting an environmental quality forecast for the plurality of environmental qualities.

15. The method of claim 14, wherein the applying the neural sub-network of the plurality of neural sub-networks to each modality of the multi-mode data associated with each environmental input feature of the plurality of environmental input features comprises:
applying a fully-connected neural sub-network to the tabular data;
applying a recurrent neural sub-network to the time-series data; and
applying a convolutional neural sub-network to the satellite image data.

16. The method of claim 14, wherein the applying the neural sub-network of the plurality of neural sub-networks to each modality of the multi-mode data associated with each environmental input feature of the plurality of environmental input features is performed simultaneously for the plurality of neural sub-networks.

17. The method of claim 14, wherein the forecasted plurality of environmental qualities comprises air quality, soil quality, and water quality.

18. The method of claim 14, wherein the plurality of neural sub-networks comprises a recurrent neural sub-network, a fully-connected neural sub-network, and a convolutional neural sub-network.

19. The method of claim 14, wherein neural subnetworks are combined using a fully-connected neural network.
